(19) United States
(12) Patent Application Publication
(10) Pub. No.: US 2022/0400079 A1
(43) Pub. Date: Dec. 15, 2022

(54) SORT DEVICE, SORT METHOD, AND SORT PROGRAM

(71) Applicant: Nippon Telegraph and Telephone Corporation, Tokyo (JP)

(72) Inventors: Yuhei HAYASHI, Musashino-shi, Tokyo (JP); Hiroshi OSAWA, Musashino-shi, Tokyo (JP); Chiharu MORIOKA, Musashino-shi, Tokyo (JP); Hiroki INOUE, Musashino-shi, Tokyo (JP); Takeaki NISHIOKA, Musashino-shi, Tokyo (JP); Yuki MIYOSHI, Musashino-shi, Tokyo (JP)

(21) Appl. No.: 17/776,299

(22) PCT Filed: Nov. 13, 2019
(86) PCT No.: PCT/JP2019/044603

§ 371 Date: May 12, 2022

(51) Int. Cl. H04L 47/122; H04L 47/35

(52) U.S. Cl. CPC H04L 47/122; H04L 47/35

(57) ABSTRACT

The sorting unit (10) has a sorting function unit (13) that acquires a frame and a sorting key, embeds the sorting key in a header of the frame, and sorts the frame into a processing thread based on the value of the sorting key in the header.

### TECHNICAL FIELD

The present invention relates to a sorting apparatus, a sorting method, and a sorting program.

### BACKGROUND ART

Conventionally, there is a router function (IPFIX 1E315, sFlow Header Sampling, etc.) that samples the first byte of a packet and sends it as xFlow. When this function is applied to a router in a network through which a tunneling packet flows, the Outer part and Inner part of the tunneling packet are sampled at the same time. For this reason, the router can perform communication flow analysis of an Inner packet included in a tunnel passing through a certain router by counting pairs of an Outer part and an Inner part of a sample for each exporter.

### CITATION LIST

### Non-Patent Literature

[NPL 1] “Overview of Receive Side Scaling”, [searched for on Nov. 7, 2019], Internet <URL: https://docs.microsoft.com/ja-jp/windows-hardware/drivers/network/introduction-to-receive-side-scaling>

### SUMMARY OF THE INVENTION

### Technical Problem

In this router function, processing threads are parallelized to distribute the load in order to improve communication flow analysis.

FIG. 7 is a diagram illustrating packet sorting processing according to the conventional technique. In FIG. 7, a case in which a header sampling xFlow packet such as IPFIX 1E315, sFlow header sampling, in which the information of the Inner part of the tunnel packet is held in the user header, is input to a general-purpose server is described as an example (see (1) in FIG. 7). As shown in FIG. 7, if the processing threads are parallelized in order to improve the processing capacity per housing, sorting needs to be performed such that xFlow packets with the “same sending source exporter” and the “same Outer header in the sample” are processed by the same processing thread (see (2) in FIG. 7). This is done so that the statistical processing of Inner packets with the same Outer header sent from the same exporter is completed by the same processing thread.

FIGS. 8 and 9 are diagrams illustrating packet distribution processing according to the conventional technique. As shown in FIG. 8, the RSS (Receive Side Scaling) function described in NPL 1 is an HW function of an NIC (Network Interface Card) for performing load distribution of packet processing based on a 5-tuple, which is information that is present at a fixed position of a packet. That is, according to the RSS (Receive Side Scaling) function, packets can be sorted on a 5-tuple basis.

Here, in the analysis of the tunneled flow, the header sampling xFlow is sorted in the same processing thread for each tunnel of the transmission source collector in order to analyze the communication flow in the tunnel, and signal flow analysis is completed.

However, in the case of a tunneled flow, header sampling flow packets sent from the same exporter to a certain collector all have the same header value (see (1) in FIG. 9). For this reason, when 5-tuple-based sorting is executed on a tunneled flow, there is a problem in that the sorting destination is biased and load balancing cannot be performed (see (2) in FIG. 9).

The present invention has been made in view of the above, and an object of the present invention is to provide a sorting apparatus, a sorting method, and a sorting program capable of appropriately executing load distribution of processing threads that perform communication flow analysis.

### Means for Solving the Problem

In order to solve the above-described problem and achieve the object, the sorting apparatus according to the present invention includes a sorting function unit configured to acquire a frame and a sorting key, embed the sorting key in a header of the frame, and sort the frame into a processing thread based on a value of the sorting key in the header.

Also, a sorting method according to the present invention is a sorting method to be executed by a sorting apparatus, including a step of acquiring a frame and a sorting key, embedding the sorting key in a header of the frame, and sorting the frame into a processing thread based on a value of the sorting key in the header.

Also, the sorting program according to the present invention cause a computer to execute a step of acquiring a frame and a sorting key, embedding the sorting key in a header of the frame, and sorting the frame into a processing thread based on a value of the sorting key in the header.

### Effects of the Invention

According to the present invention, it is possible to perform communication flow analysis while distributing the load of processing threads with respect to a tunneled flow.

### BRIEF DESCRIPTION OF DRAWINGS

FIG. 1 is a diagram illustrating sorting processing according to an embodiment.

FIG. 2 is a diagram showing an example of a configuration of a processing apparatus according to an embodiment.

FIG. 3 is a diagram illustrating a flow of sorting processing performed by a sorting unit shown in FIG. 2.

FIG. 4 is a diagram illustrating a flow of sorting processing performed by the sorting unit shown in FIG. 2.

FIG. 5 is a diagram illustrating a processing procedure for sorting processing according to an embodiment.

FIG. 6 is a diagram showing an example of a computer in which a processing apparatus is realized due to a program being executed.

FIG. 7 is a diagram illustrating packet sorting processing according to a conventional technique.

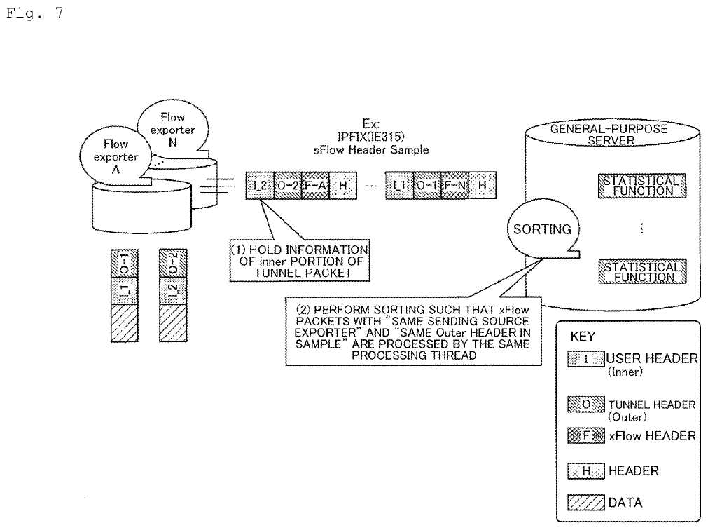

FIG. 8 is a diagram illustrating packet sorting processing according to a conventional technique.

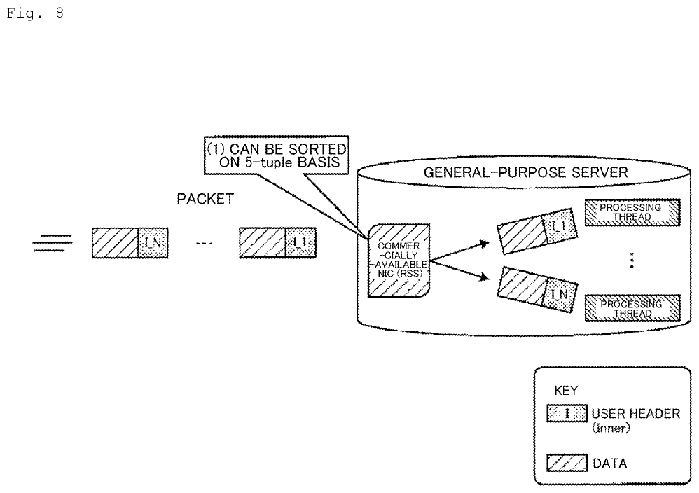

FIG. 9 is a diagram illustrating packet sorting processing according to a conventional technique.

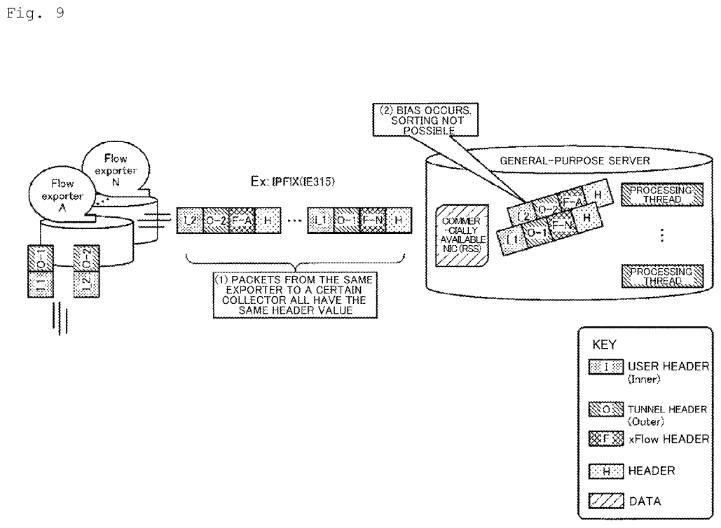

### DESCRIPTION OF EMBODIMENTS

Hereinafter, an embodiment of the present invention will be described in detail with reference to the drawings. Note that the present invention is not limited to this embodiment. Also, in the description of the drawings, identical parts are denoted by identical reference numerals.

### Embodiment

Sorting Mechanism of the Present Embodiment

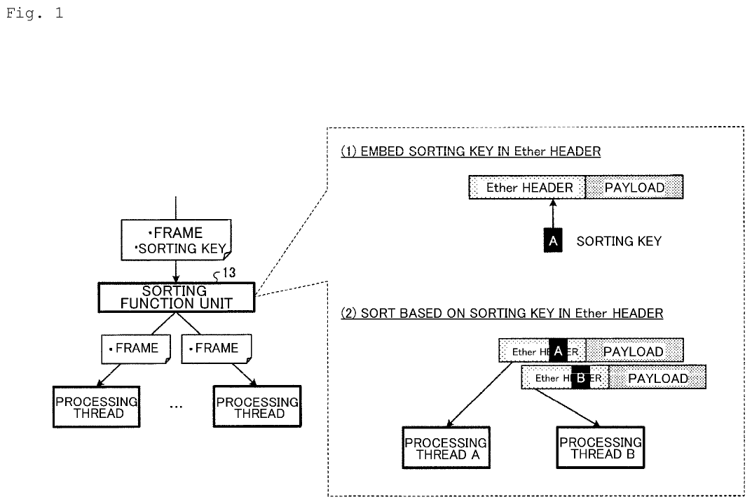

FIG. 1 is a diagram illustrating sorting processing according to an embodiment. As shown in FIG. 1, sorting processing performed by a sorting function unit 13 according to the present embodiment will be described. The sorting function unit 13 according to the present embodiment acquires a frame and a sorting key, embeds the sorting key in the header of the frame, and sorts the frame into a processing thread based on the value of the sorting key in the header.

Specifically, the sorting function unit 13 embeds, for example, a sorting key “A” in an Ether header of an Ether frame based on the frame and the sorting key (see (1) in FIG. 1). Then, the sorting function unit 13 sorts the frame into the processing thread performing communication flow analysis based on the sorting key in the Ether header (see (2) in FIG. 1).

In the case of the example of FIG. 1, the sorting function unit 13 sorts the frame in which “A” is embedded in the Ether header into the processing thread A. Also, the sorting function unit 13 sorts the frame in which “B” is embedded in the Ether header into the processing thread B.

As described above, in the embodiment, the frame and the sorting key are acquired, the sorting key is embedded in the Ether header of the frame, and the frame is sorted into a processing thread based on the value of the sorting key in the Ether header. For this reason, according to the present embodiment, it is possible to analyze the communication flow while performing load distribution of the processing thread even for a tunneled flow.

Overview of Processing Apparatus

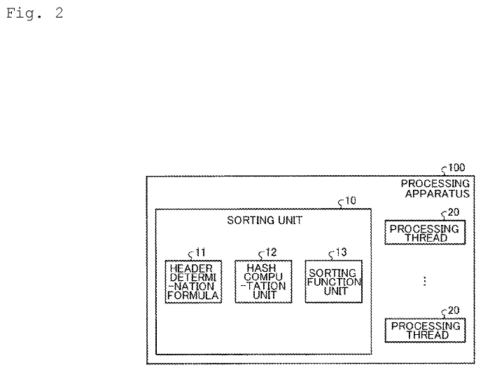

First, a configuration of a processing apparatus according to the embodiment will be described with reference to FIG. 1. FIG. 2 is a diagram showing an example of the configuration of the processing apparatus according to the embodiment. In a processing apparatus 100 shown in FIG. 2, communication flow analysis is performed by sorting tunneling packets in the frame into the processing threads. In particular, a case in which the processing apparatus 100 uses header sampling xFlow (e.g., sFlow header sampling, IPFIX 1E315) to perform sorting of flow packets (header sampling packets) obtained by sampling part of the beginning of the tunneling packet inside of a network performing tunneling as appropriate for packet transfer will be described as an example.

The processing apparatus 100 is realized by, for example, loading a predetermined program in a computer or the like including a ROM (Read Only Memory), a RAM (Random Access Memory), a CPU (Central Processing Unit), and the like, and executing the predetermined program with the CPU. Also, the processing apparatus 100 has a communication interface for transmitting and receiving various types of information to and from another apparatus connected via a network or the like. The processing apparatus 100 has an NIC (Network Interface Card) and the like, and performs communication with another apparatus via a telecommunication line such as a LAN (Local Area Network) or the Internet.

As shown in FIG. 2, the processing apparatus 100 includes a sorting unit 10 (sorting apparatus) that performs sorting of flow packets, and a plurality of parallelized processing threads 20 that perform signal flow analysis.

Configuration of Sorting Unit

Next, the configuration of the sorting unit 10 will be described. The sorting unit 10 sorts a flow packet whose input has been received into a processing thread using the function of the above-described sorting function unit 13.

The sorting unit 10 is arranged at the entrance of the reception housing of the header sampling xFlow packet, performs sorting of the flow packets into a plurality of flow packet processing threads based on the xFlow header information and the information of the Outer header in the samples, thereby enabling load distribution of the processing threads. Note that the flow packet input to the sorting unit 10 is a packet in which any protocol header added to the Ether header for tunneling is stacked. Also, packets for a certain collector from the same exporter all have the same header value. The sorting unit 10 has a header determination unit 11 (determination unit), a hash computation unit 12 (calculation unit), and a sorting function unit 13.

The header determination unit 11 analyzes the flow packet and determines the xFlow header information and the Outer header position in the sample. The header determination unit 11 performs protocol stack analysis of the flow packet and specifies the xFlow header information and the Outer header position in the sample.

For example, the header determination unit 11 may also determine the type of header, the Outer header in the sample, and the like using the method described in Japanese Patent Application Laid-Open No. 2019-097069. The header determination unit 11 determines the protocol stack pattern indicating the type and arrangement of each protocol header of the input flow packet according to a determination rule. The protocol stack pattern is information indicating the type and arrangement of each protocol header.

Specifically, the header determination unit 11 determines the protocol stack pattern of the input packet using a determination tree for determining a protocol stack pattern created by sequentially searching for a packet with a known protocol stack pattern starting from a lower-level header, a determination logical expression for determining a protocol stack pattern created based on a specific bit string in a packet with a known protocol stack pattern, or a protocol config file showing the header information of each standardized protocol. The determination rule may be generated in advance by another apparatus, or may be generated by learning the input packet using the protocol config file. Note that the header determination unit 11 may also determine the header using another method.

The hash computation unit 12 performs hash computation using the xFlow header information and the Outer header position in the sample as inputs, and outputs the hash value. The hash computation unit 12 outputs the same hash value for flows having the same exporter and the same Outer header. This hash value functions as a sorting key.

The sorting function unit 13 writes the hash value output from the hash computation unit 12 as a sorting key in the Ether header of the flow packet, and sorts the flow packet into a processing thread based on the Ether header. Since the same hash value is embedded as a sorting key for flows having the same exporter and the same Outer header, the sorting function unit 13 can sort each flow packet into the corresponding processing thread.

Flow of Sorting Processing

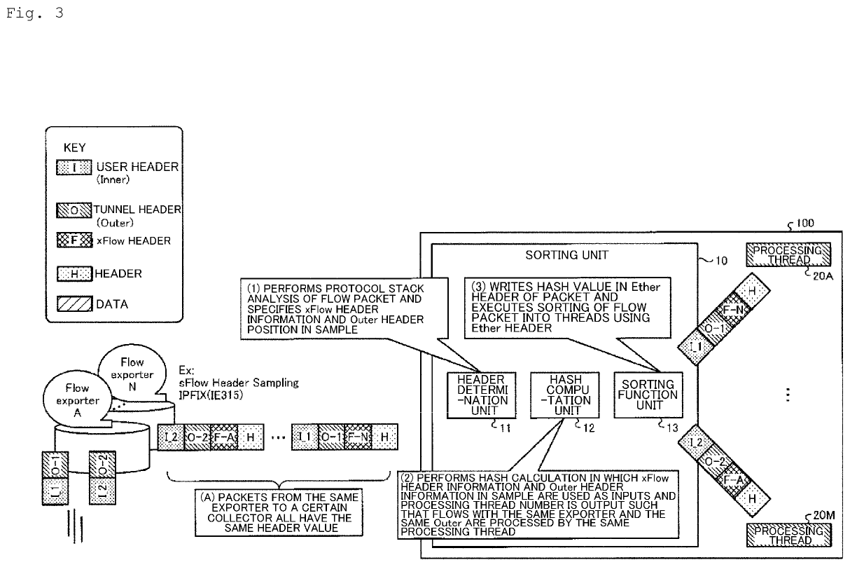

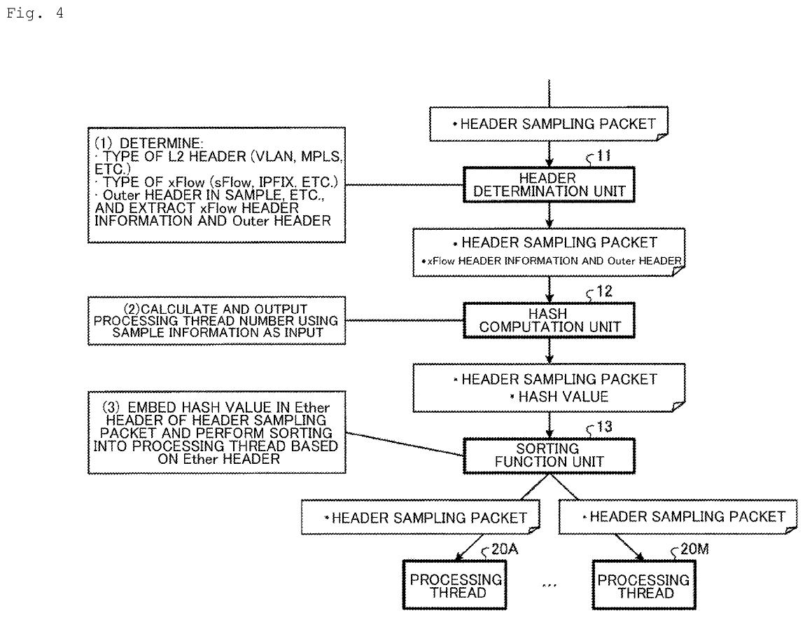

Next, a flow of sorting processing performed by the sorting unit 10 shown in FIG. 2 will be described with reference to FIGS. 3 and 4. FIGS. 3 and 4 are diagrams for illustrating the flow of sorting processing performed by the sorting unit shown in FIG. 2.

As shown in FIG. 3, with the header sampling packets, packets for a certain collector from the same exporter all have the same header value. The sorting unit 10 performs the processing of the subsequent flow in order to suitably sort these packets.

First, the header determination unit 11 performs protocol stack analysis of the flow packet and specifies the xFlow header information and the Outer header position in the sample (see (1) in FIG. 3). Specifically, when the header determination unit 11 receives input of a header sampling packet, the header determination unit 11 determines the type of the L2 header (VLAN (Virtual LAN), MPLS (Multi-Protocol Label Switching), etc.), the type of the xFlow (sFlow, IPFIX, etc.), the Outer header in the sample, and the like (see (1) in FIG. 4). Then, the header determination unit 11 extracts the xFlow header information and the Outer header of this header sampling packet as sample information based on the determination result (see (1) in FIG. 4), and outputs the sample information to the hash computation unit 12.

The hash computation unit 12 performs hash calculation in which the xFlow header information and the Outer header information in the sample are used as inputs and the processing thread number is output, such that flows with the same exporter and the same Outer are processed by the same processing thread (see (2) in FIG. 3). That is, the hash computation unit 12 calculates and outputs the processing thread number using the sample information output from the header determination unit 11 as input (see (2) in FIG. 4).

The sorting function unit 13 embeds the hash value output from the hash computation unit 12 in the Ether header of the header sampling packet, and performs sorting into a processing thread based on the Ether header (see (3) in FIG. 3 and (3) in FIG. 4).

As a result, as shown in FIG. 3, since the hash value of the packet with the Outer header “O-1” is embedded in the Ether net as a sorting key using the xFlow header information “F-N” and the Outer header “O-1” as inputs, this packet is sorted into the processing thread 20A according to this sorting key. By contrast, since the hash value of the packet with the Outer header “O-2” is embedded in the Ether net as the sorting key using the xFlow header information “F-A” and the Outer header “O-2” as inputs, this packet is sorted into the processing thread 20M according to this sorting key.

Processing Procedure for Sorting Processing

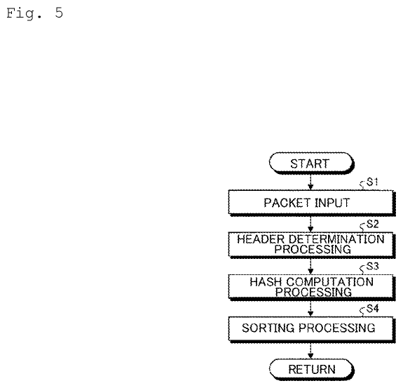

Next, a processing procedure for sorting processing performed by the sorting unit 10 will be described. FIG. 5 is a diagram illustrating a processing procedure for sorting processing according to the embodiment.

As shown in FIG. 5, upon receiving input of a packet (step S1), the header determination unit 11 analyzes the flow packet and performs header determination processing for determining the xFlow header information and the Outer header position in the sample (step S2).

Next, the hash computation unit 12 performs hash computation processing for performing hash calculation using the xFlow header information and the Outer header position in the sample as inputs, and outputting the hash value (step S3).

Then, the sorting function unit 13 writes the hash value output from the hash computation unit 12 as a sorting key in the Ether header of the flow packet, and performs sorting processing for sorting the flow packet into a processing thread based on the Ether header (step S4).

### Effect of Embodiment

In this manner, in the embodiment, the frame and the sorting key are acquired, the sorting key is embedded in the header of the frame, and the frame is sorted into a processing thread based on the value of the sorting key in the header. According to the present embodiment, load distribution of the processing threads can be appropriately executed by sorting the frame into the processing thread using the value of the sorting key in the header.

Also, the sorting unit 10 according to the embodiment analyzes a packet to which any protocol header has been added after the Ether header for tunneling, and determines the xFlow header information and the Outer header position in the sample. Then, the sorting unit 10 performs hash calculation using the xFlow header information and the Outer header position in the sample as inputs, and outputs the hash value. The sorting unit 10 writes the hash value as a sorting key in the Ether header of the packet, and sorts the packet into a processing thread based on the Ether header.

In this manner, in the present embodiment, the hash value to be used as the sorting key is calculated using the xFlow header information and the Outer header position in the sample as inputs. For this reason, in the present embodiment, packets having the same xFlow header information and Outer header position in the sample are sorted into the same processing thread because the same hash value is used as the sorting key.

Accordingly, in the present embodiment, through tunneling, even if the packets all have the same header value, signal flow analysis of Inner packets from the same exporter and to which the same Outer is attached can be completed by the same processing thread. For this reason, according to the present embodiment, signal flow analysis can be executed with high accuracy. Then, according to the present embodiment, sorting to a processing thread can be appropriately executed even for a tunneled flow, and therefore load distribution can be suitably executed.

System Configuration, Etc.

The constituent elements of each illustrated apparatus are functional concepts and do not necessarily need to be physically constituted as shown in the drawings. That is, the specific mode of distribution/integration of each apparatus is not limited to that shown in the drawings, and all or part of the apparatus can be formed functionally or physically distributed or integrated in any unit according to various types of loads, usage conditions, and the like. Furthermore, all or a portion of the processing functions performed by each apparatus may be realized by a CPU and a program analyzed and executed by the CPU, or may be realized as hardware according to wired logic.

Also, among the processes described in the present embodiment, all or some of the processing described as being automatically performed can also be manually performed, or all or some of the processing described as being manually performed can also be automatically performed using a known method. In addition, the processing procedure, control procedure, specific names, and information including various types of data and parameters shown in the above-described document and drawings can be changed as appropriate unless otherwise specified.

Program

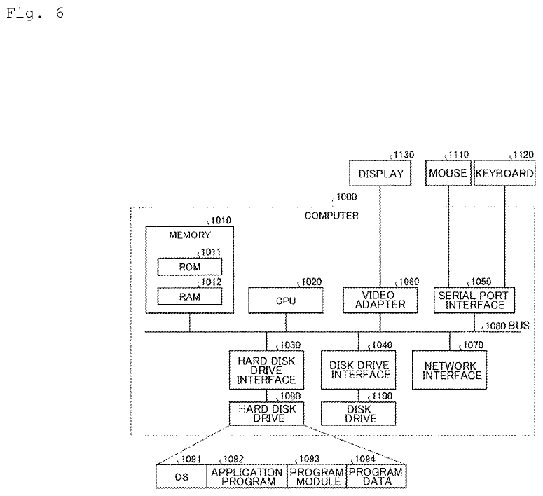

FIG. 6 is a diagram showing an example of a computer in which the processing apparatus 100 is realized by executing a program. The computer 1000 has, for example, a memory 1010 and a CPU 1020. The computer 1000 also has a hard disk drive interface 1030, a disk drive interface 1040, a serial port interface 1050, a video adapter 1060, and a network interface 1070. Each of these parts is connected by a bus 1080.

The memory 1010 includes a ROM 1011 and a RAM 1012. The ROM 1011 stores, for example, a boot program such as a BIOS (Basic Input Output System). The hard disk drive interface 1030 is connected to the hard disk drive 1090. The disk drive interface 1040 is connected to the disk drive 1100. For example, a removable storage medium such as a magnetic disk or an optical disk is inserted into the disk drive 1100. The serial port interface 1050 is connected to, for example, a mouse 1110 and a keyboard 1120. The video adapter 1060 is connected to, for example, the display 1130.

The hard disk drive 1090 stores, for example, an OS (Operating System) 1091, an application program 1092, a program module 1093, and program data 1094. That is, the program that defines each process of the processing apparatus 100 is implemented as a program module 1093 in which a code that can be executed by a computer is described. The program module 1093 is stored in, for example, the hard disk drive 1090. For example, a program module 1093 for executing processing similar to that of the functional configuration of the processing apparatus 100 is stored in the hard disk drive 1090. Note that the hard disk drive 1090 may also be replaced by an SSD (Solid State Drive).

Also, the setting data to be used in the processing of the above-described embodiment is stored as the program data 1094 in, for example, the memory 1010 or the hard disk drive 1090. Then, the CPU 1020 reads out the program module 1093 and the program data 1094 stored in the memory 1010 and the hard disk drive 1090 to the RAM 1012 and executes them as needed.

Note that the program module 1093 and the program data 1094 are not limited to a case of being stored in the hard disk drive 1090, and may also be stored in, for example, a removable storage medium and read out by the CPU 1020 via the disk drive 1100 or the like. Alternatively, the program module 1093 and the program data 1094 may also be stored in another computer connected via a network (a LAN, a WAN (Wide Area Network), etc.). Then, the program module 1093 and the program data 1094 may be read out by the CPU 1020 from the other computer via the network interface 1070.

Although an embodiment to which the invention made by the present inventor is applied has been described above, the present invention is not limited by the description and the drawings, which form part of the disclosure of the present invention according to the present embodiment. That is, other embodiments, examples, operational techniques, and the like made by those skilled in the art based on the present embodiment are all encompassed in the scope of the present invention.

### REFERENCE SIGNS LIST

100 Processing apparatus
10 Sorting unit
11 Header determination unit
12 Hash computation unit
13 Sorting function unit
20 Processing thread

1. A sorting apparatus comprising
a sorting function unit, including one or more processors, configured to acquire a frame and a sorting key, embed the sorting key in a header of the frame, and sort the frame into a processing thread based on a value of the sorting key in the header.

2. The sorting apparatus according to claim 1, further comprising:
a determination unit, including one or more processors, configured to analyze a packet in which any protocol header has been added to an Ether header for performing tunneling, and determine xFlow header information and an Outer header position in a sample; and
a calculation unit, including one or more processors, configured to perform hash calculation using the xFlow header information and the Outer header position in the sample as inputs, and perform hash calculation for outputting a hash value,
wherein the sorting function unit is configured to write the hash value as the sorting key in the Ether header of the packet and sorts the packet into a processing thread based on the Ether header.

3. The sorting apparatus according to claim 2,
wherein the determination unit is configured to determine a protocol stack pattern, which indicates a type and arrangement of each protocol header, of an input packet using a determination tree for determining a protocol stack pattern created by sequentially searching for a packet with a known protocol stack pattern starting from a lower-level header, a determination logical expression for determining a protocol stack pattern created based on a specific bit string in a packet with a known protocol stack pattern, or a protocol config file showing header information of each standardized protocol.

4. A sorting method to be executed by a sorting apparatus, comprising
a step of acquiring a frame and a sorting key, embedding the sorting key in a header of the frame, and sorting the frame into a processing thread based on a value of the sorting key in the header.

5. A non-transitory computer readable medium storing a sorting program for causing a computer to execute
a step of acquiring a frame and a sorting key, embedding the sorting key in a header of the frame, and sorting the frame into a processing thread based on a value of the sorting key in the header.

6. The sorting method according to claim 4, further comprising:
analyzing a packet in which any protocol header has been added to an Ether header for performing tunneling, and determine xFlow header information and an Outer header position in a sample;
performing hash calculation using the xFlow header information and the Outer header position in the sample as inputs, and perform hash calculation for outputting a hash value; and
writing the hash value as the sorting key in the Ether header of the packet and sorts the packet into a processing thread based on the Ether header.

7. The sorting method according to claim 6, further comprising:
determining a protocol stack pattern, which indicates a type and arrangement of each protocol header, of an input packet using a determination tree for determining a protocol stack pattern created by sequentially searching for a packet with a known protocol stack pattern starting from a lower-level header, a determination logical expression for determining a protocol stack pattern created based on a specific bit string in a packet with a known protocol stack pattern, or a protocol config file showing header information of each standardized protocol.

8. The non-transitory computer readable medium according to claim 5, wherein the sorting program further causes the computer to execute:
analyzing a packet in which any protocol header has been added to an Ether header for performing tunneling, and determine xFlow header information and an Outer header position in a sample;
performing hash calculation using the xFlow header information and the Outer header position in the sample as inputs, and perform hash calculation for outputting a hash value; and
writing the hash value as the sorting key in the Ether header of the packet and sorts the packet into a processing thread based on the Ether header.

9. The non-transitory computer readable medium according to claim 8, wherein the sorting program further causes the computer to execute:
determining a protocol stack pattern, which indicates a type and arrangement of each protocol header, of an input packet using a determination tree for determining a protocol stack pattern created by sequentially searching for a packet with a known protocol stack pattern starting from a lower-level header, a determination logical expression for determining a protocol stack pattern created based on a specific bit string in a packet with a known protocol stack pattern, or a protocol config file showing header information of each standardized protocol.
